(19) United States
(12) Patent Application Publication
(10) Pub. No.: US 2019/0021389 A1
(43) Pub. Date: Jan. 24, 2019

(54) PROCESS FOR THE PREPARATION OF PELLETS

(71) Applicants: SUEDZUCKER AG, Mannheim (DE); BIOWANZE N.V., Brussels (BE)

(72) Inventors: Hans-Joerg MENGER, Reilingen (DE); Ralf MOELLER, Vinalmont (BE); Andre TONNEAUX, Erpent (Namur) (BE)

(73) Assignees: SUEDZUCKER AG, Mannheim (DE); BIOWANZE N.V., Brussels (BE)

(21) Appl. No.: 16/069,140

(22) PCT Filed: Jan. 11, 2017
(86) PCT No.: PCT/EP2017/000027

§ 371 Date: Jul. 10, 2018

(30) Foreign Application Priority Data
Jan. 11, 2016 (EP) 16000026

(51) Int. Cl. A23P 10/25; A23K 40/25

(52) U.S. Cl. CPC A23P 10/25; A23K 50/80; A23K 40/25

(57) ABSTRACT

The disclosure provides a process for the preparation of pellets containing wheat gluten, including: ⋅A preparatory step, in which a raw material containing at least 50 wt. % wheat gluten is brought to a particle size distribution having a D₉₀ of at most 175 μm, to form a feeding material; and ⋅A pelletizing step, in which the feeding material is formed into pellets.

The invention relates to a process for the preparation of pellets containing wheat gluten.

Such a process is as such known from EP-A-1 785 039. The known process comprises the steps of feeding protein comprising vital wheat gluten into a suitable equipment, pouring the heated proteins through a die for obtaining pellets, and collecting the pellets. The proteins in the known process are preferred to have a certain particle size, such that at least 15 wt. % have a particle size of 200 μm or more.

It is a disadvantage of the known process that the physical stability of the pellets, expressed in pellet durability index (PDI), is not always optimal.

It is the objective of the present invention to reduce the said disadvantage.

The said objective is achieved in that the process comprises:
A preparatory step, in which a raw material containing at least 50 wt. % wheat gluten is brought to a particle size distribution having a D₉₀ of at most 175 μm, to form a feeding material; and
A pelletizing step, in which the feeding material is formed into pellets using suitable means.

It is an advantage of the invention that the pellets produced according to the invention can have an increased physical stability, as expressed in PDI.

WO-A-2010/004196 relates to protein pellets comprising wheat gluten, characterized in that the said gluten has: a water retention capacity, determined according to a test A, of between 40 and 160%, preferably between 100 and 150%; and a viscoelastic behaviour, according to the

Chopin Alvéograph, determined at a P/L parameter value of between 3 and 10, preferably between 3 and 8. The raw material (gluten powder) is preferably characterised in that 20%, preferably at least 50%, have a size of 250 μm or more.

WO-A-2015/063261 relates to a process for preparing pellets of compressed proteins comprising vital gluten, pellets obtainable by such a process and an apparatus used in such a process. The raw material (gluten powder) is mixed with a humectant, comprising a liquid compound. The raw material (gluten powder) is preferably characterised in that the D₉₀ is at most 500, 350, or 250 μm.

U.S. Pat. No. 3,925,343 discloses that powdered vital wheat gluten is difficult to disperse in water and a dispersion, once obtained, is unstable since individual particles readily coalesce with the formation of an intractable, lumpy mass. By converting the powdered gluten into novel structures in the form of agglomerates thereof under conditions which do not denature the gluten, the gluten can be readily wetted out and dispersed in water to form a relatively stable dispersion. Accordingly, the agglomerated gluten is ideally suited for the manufacture of yeast leavened bakery products, especially by continuous dough-making processes.

The process of the invention relates to the preparation of pellets containing wheat gluten. Such pellets have gained significant commercial interest in recent years, as they are used—amongst others—as raw material by producers of aquafeed pellets. The pellets often are cylindrical having a diameter of several mm, preferably between 3 mm and 8 mm or between 4 and 7 mm, and a length of typically from about 5 mm up to about 40 mm, preferably up to 30 or 25 mm. Wheat gluten is as such a well-known material, which can be produced for example as co-product in a bioethanol plant that uses wheat as the raw material. Wheat gluten typically contains a high amount of proteins, preferably 70 wt. % or more (on dry matter), the rest consisting essentially of other fractions originating from the wheat and/or from wheat processing steps. The other fractions can, as is commonly known, consist of carbohydrates such as non-starch polysaccharides, lipids, and yet further compounds. As meant herein, the term wheat gluten is used in its customary meaning wherein it not only consists of the—preferably at least 70 wt. %—proteins but also contains the said other fractions.

In the preparatory step of the process of the invention, a raw material is provided. The raw material should be in the form of particles and should contain at least 50 wt. % wheat gluten; preferably, the raw material contains at least 70, 75, 80, 85, 90, or even at least 95 wt. % wheat gluten. Most preferably, the raw material consists essentially of wheat gluten or even consists of wheat gluten.

As used herein, the terms ‘essentially’, ‘consist(ing) essentially of’, ‘essentially all’ and equivalents have, unless noted otherwise, in relation to a composition or a process step the usual meaning that deviations in the composition or process step may occur, but only to such an extent that the essential characteristics and effects of the composition or process step are not materially affected by such deviations.

Preferably, the gluten as used in the process of the invention is vital. In the context of the present invention, a gluten is said to be vital if the water binding capacity, determined via the known method AACC 56-30, is at least 130%. In a preferred embodiment, the gluten as used in the process of the invention is highly vital, i.e. its water binding capacity is at least 140%.

According to the preparatory step of the invention, the raw material should be brought to a specific particle size distribution, such that it has a Dₛₒ of at most 175 μm, to form the feeding material.

As is known, the expression that a collection of particles has a ‘D_{α} of β’ means that α wt. % of all particles in the collection have a size of at most β.

The particle size information as given or specified herein is determined or should be determined via sieving, a method as such well known. The specific method to be used for determining particle size information according to the invention is the method as disclosed in DIN 66165, part 2, chapter 7.

Wheat gluten is often released from its production process in the form of a powder; if this is not the case, it should be brought into a particulate form. In order to be suitable as the feeding material for the pelletizing step of the invention, the raw material as a whole should have a particle size distribution having a D₉₀ of at most 175 μm. If a material does not satisfy this condition by having more than 10 wt. % of particles of more than 175 μm in size, it should be brought to the appropriate particle size distribution; this can be achieved via means that are as such known such as for example milling or micronizing. Milling, micronizing and equivalents thereof are also the preferred methods to achieve the further preferred embodiments on particle size distribution as outlined below.

Until present, there has been a clear preference in the art for the presence in the raw material of a significant portion at least 15 wt. % or more of particles having a size significantly above 200 μm. This is consistent with the known reputation of wheat gluten powder, which is reputed to be a difficult to handle powder, especially when it concerns smaller particles. Surprisingly, however, it was found that the raw material as defined herein according to the invention is well-suited for pelletizing processes; moreover, it was found that pellets so produced can have improved properties.

Preferably, the raw material is brought to a particle size distribution such that at least 90 wt. % of the feeding material is at most 160, 150, or even at most 140 μm in size.

The feeding material preferably has a D₅₀ of at least 30 or 40 μm and at most 80 μm; more preferably, at least 55 or 60 wt. % of the feeding material is at most 80 μm in size. The feeding material preferably has a D₇₅ of at least 40 or 50 μm and at most 100 μm.

In a main preferred embodiment of the invention the feeding material has a D₅₀ of at least 40 μm and at most 80 μm, a D₇₅ of at least 50 μm and at most 100 μm, and a D₉₀ of at least 60 μm and at most 175 μm.

In another preferred embodiment of the invention the feeding material has a D₅₅ of at least 45 μm and at most 80 μm, a D₇₅ of at least 60 μm and at most 100 μm, and a D₉₀ of at least 70 μm and at most 160 μm.

In yet another preferred embodiment of the invention the feeding material has a D₅₅ of at most 80 μm, a D₇₅ of at most 100 μm, and a D₉₀ of at least 80 μm and at most 150 μm or 140μm.

For practical reasons, it is preferred that the D₉₀ of the feeding material is at least 50 μm, more preferably at least 60 or 70 μm. In a further preferred embodiment, the D₉₀ of the feeding material is at least 80, 90, 100, 110, 120, or even at least 130 μm. In these preferred embodiments, the D₉₀ is preferably at most 175, 170, 165, 160, 155, 150, 145, or 140 μm.

According to the invention, the preparatory step is followed by a pelletizing step, in which the feeding material is formed into pellets using suitable means. It is however advantageous, before the feeding material enters the pelletizing step and is formed into pellets, to adjust the water content and/or the temperature of the feeding material.

Preferably, the feeding material is humidified prior to being formed into pellets. The humidification is preferably done by means of a liquid, a vapour, or a mixture thereof, and preferably by using an aqueous humidifier. Example of suitable humidifiers are: water, steam, vinasse, molasses, and mixtures thereof. When using an aqueous humidifier, it is preferred to bring the water content of the feeding material to at least 5 or 6 wt. %, more preferably to at least 7, 8, 9 or 10 wt. %; preferably the water content of the feeding material is brought to at most 20 or 15 wt. %, more preferably to at most 14, 13, or 12 wt. %. The humidification can be done by means that are as such known, such as for example a mixer, preferably using a screw and/or paddles to achieve the mixing action.

Preferably, the feeding material has or is brought to a certain temperature before the feeding material enters the pelletizing step and is formed into pellets. The temperature preferably is or is brought to at least 30° C., more preferably at least 35, 40, 45, or even to 50° C.; preferably, the temperature is or is brought to at most 100 or 90, more preferably at most 85 or 80° C. In case a rise in temperature of the feeding material is desired, the temperature adjustment can advantageously be done at least partially by means of the addition of steam to the feeding material.

Regarding the pelletizing step of the invention it was found that means that are suitable for known preparation methods of pellets containing wheat gluten such as a pellet press are, possibly after some routine experimentations, typically also suitable for the forming of pellets according to the invention. It was surprisingly found that—at least on common industrial-scale pellet presses, also referred to as pellet mills—no significant adjustment of parameters may be necessary, even though it was expected in the art that the handling and processing of finer particles of wheat gluten is more cumbersome and often even not feasible.

Besides pellet presses, extruders are a further example of means suitable for executing the pelletizing step of the invention.

As is known, it is a common characteristic of means for pelletizing that a pressure is imposed onto the feeding material as one contributing factor to achieving the pellet shape. Consequently, the pelletizing step in the process of the invention causes an increase in the bulk density. This increase in bulk density during the pelletizing step is in contrast to the effect on bulk density of agglomerating steps such as the one disclosed in U.S. Pat. No. 3 925 343 which typically lead to a decrease of bulk density. The pelletizing step of the invention is not executed by means of an agglomerating step as disclosed in U.S. Pat. No. 3,925,343 or equivalents thereof. Thus, the pelletizing step of the invention is not executed by means of a fluid bed or any one of the other agglomerating methods as disclosed in U.S. Pat. No. 3 925 343.

In a preferred embodiment of the invention, the pelletizing step causes an increase of bulk density from the feeding material to the pellets of at least 50 kg/m³, more preferably at least 100 kg/m³. In order to secure optimal properties of the wheat gluten, it was found that it is favourable that the increase in bulk density from the feeding material to the pellets is at most 350 kg/m³, preferable at most 300 or 250 kg/m³. The resulting pellets preferably have a bulk density lying between 450 and 700 kg/m³, more preferably between 475 and 675 kg/m³, most preferably between 500 and 650 kg/m³.

The invention will be illustrated with the Example below, without being limited thereto.

### EXAMPLE 1

Pellets consisting of vital wheat gluten were produced in an industrial-size Bühler Pellet Mill DPHD with an inner diameter of 650 mm, having die holes of 6 mm wide and 60 mm deep.

In Example 1, a vital wheat gluten was first milled in order to achieve a feeding material having particle size distribution according to the invention (see Table 1 below). Immediately prior to being subjected to the pelletizing step, the feeding material was humidified by mixing with 5 wt. % steam, after which it had an average temperature of 61° C. and a water content of 11 wt. %. Pelletizing was done with a throughput of 6.1 tonnes per hour. The pellets produced had a water content of 8.7 wt. %.

The pellet durability index (PDI) of the pellets was determined by means of a Holmen NHP 100 pellet tester. The test length was 60 seconds, the pressure was set at 60 mbar. The PDI was determined in the usual way by measuring the weight of the pellets before and after the test and calculating the percentage of weight remaining:

PDI=100×(mass of pellets after the test)/(mass of pellets before the test)

The average PDI was determined to be 96.4%.

### Comparative Experiment A

Vital wheat gluten from the same batch that was used in Example 1 was, in its un-milled form, used for Comparative Experiment A. Pellets were produced in the same installation as was used in Example 1, at the same throughput and using the same amount of steam.

The average PDI of the pellets produced was determined to be 94.9%, i.e. 1.5% lower than the average PDI of the pellets of Example 1.

The size fractions of the feeding material as given in Table 1 were obtained via sieving.

TABLE 1

| | Example 1 | Comparative Experiment A |
|---|---|---|
| | Milled gluten | Unmilled gluten |
| Size fractions | (wt. %) | (wt. %) |
| Up to 80 μm | 65 | 28 |
| 80 to 100 μm | 20 | 15 |
| 100 to 140 μm | 11 | 17 |
| 140 to 160 μm | 2 | 7 |
| 160 to 200 μm | 1 | 9 |
| 200 to 280 μm | 0.5 | 11 |
| Rest (280 μm and bigger) | 0.5 | 13 |

From Table 1 it follows that the D₉₀ of the gluten according to Example 1 lies between 100 and 140 μm, whereas the D₉₀ of the gluten according to Comparative Experiment A has a value greater than 280 μm.

1. A process for the preparation of pellets containing wheat gluten, comprising:
A preparatory step, in which a raw material containing at least 50 wt. % wheat gluten is brought to a particle size distribution having a D₉₀ of at most 175 μm, to form a feeding material; and
A pelletizing step, in which the feeding material is formed into pellets. means.

2. The process according to claim 1, wherein the raw material consists essentially of vital wheat gluten.

3. The process according to claim 1, wherein the raw material is brought to a particle size distribution wherein the D₅₀ is at most 80 μm and wherein the D₉₀ is at least 60 μm.

4. The process according to claim 3, wherein the raw material is brought to a particle size distribution such that at least 90 wt. % of the feeding material is at most 150 μm, preferably at most 140 μm in size.

5. The process according to claim 3, wherein the raw material is brought to a particle size distribution wherein the D₅₀ is between 30 or 40 μm and 80 μm, and wherein the D₉₀ is at least 80 or 100 μm and at most 150 or 140 μm.

6. The process according to claim 3, wherein the raw material is brought to a particle size distribution wherein the D₇₅ is at least 50 or 60 μm and at most 100 μm.

7. The process according to claim 1, wherein the pelletizing step is executed in a pelletizing press.

8. The process according to claim 1, wherein the feeding material is humidified prior to being formed into pellets and/or brought to a temperature lying between 30 and 100° C.

9. The process according to claim 8, wherein the humidification is done by an aqueous liquid and/or an aqueous vapour, such that the water content of the feeding material is between 5 and 20 wt. %.

10. The process according to claim 9, wherein the water content of the feeding material is brought to between 6 and 14 wt. %.

11. The process according to claim 1, wherein the pelletizing step is executed such that the bulk density of the pellets is between 50 and 350 kg/m³ higher than the bulk density of the feeding material.

12. The process according to claim 11, wherein the pelletizing step is executed such that the bulk density of the pellets is between 100 and 250 kg/m³ higher than the bulk density of the feeding material.

13. The process according to claim 1, wherein the bulk density of the pellets is between 450 and 700 kg/m³, preferably between 500 and 650 kg/m³.

14. The process according to claim 1, wherein the pelletizing step is executed in a pellet press or in an extruder.

15. The process according to claim 1, wherein the pelletizing step is executed such that the resulting pellets have a diameter between 3 mm and 8 mm, and a length between 5 mm and 40 mm.
